(19) United States
(12) Patent Application Publication
(10) Pub. No.: US 2017/0123975 A1
(43) Pub. Date: May 4, 2017

(54) CENTRALIZED DISTRIBUTED SYSTEMS AND METHODS FOR MANAGING OPERATIONS

(71) Applicant: Samsung Electronics Co., Ltd., Suwon-si (KR)

(72) Inventors: Derrick TSENG, Union City, CA (US); Changho CHOI, San Jose, CA (US); Suraj Prabhakar WAGHULDE, Fremont, CA (US)

(21) Appl. No.: 15/042,147

(22) Filed: Feb. 11, 2016

Related U.S. Application Data
(60) Provisional application No. 62/250,409, filed on Nov. 3, 2015.

(51) Int. Cl. G06F 12/02; G06F 3/06; G06F 17/30

(52) U.S. Cl. CPC G06F 12/0269; G06F 17/30371; G06F 3/0608; G06F 3/064; G06F 3/0652; G06F 3/067

(57) ABSTRACT

An embodiment includes a system, comprising: a server coupled to a plurality of nodes and configured to: select a node from among the nodes to perform a maintenance operation; instruct the selected node to perform the maintenance operation; and respond to access requests based on the selected node; wherein performing the maintenance operation by the selected node decreases a performance of the selected node.

### CROSS-REFERENCE TO RELATED APPLICATIONS

This application claims the benefit of U.S. Provisional Patent Application No. 62/250,409, filed Nov. 3, 2015, the contents of which is hereby incorporated by reference herein, in its entirety, for all purposes.

### BACKGROUND

This disclosure relates to centralized distributed systems and, in particular, centralized distributed systems for managing operations.

Nodes of distributed systems may perform periodic operations, such as maintenance operations, file system management operations, background operations, or the like. For example, garbage collection may be performed on Solid State Drives (SSDs), which may be used in a distributed system. As data fills the SSDs, new blocks may be freed to store new data. To free new blocks, a SSD may scan the media for full erase blocks with “dirty” pages. The SSD may read the valid pages within the erase block, store that data elsewhere, and then erase the block, freeing the erased block to store new data. Garbage collection tasks can occur in the background as requests are being processed; however, garbage collection may slow down processing of write and/or read requests.

### SUMMARY

An embodiment includes a system, comprising: a server coupled to a plurality of nodes and configured to: select a node from among the nodes to perform a maintenance operation; instruct the selected node to perform the maintenance operation; and respond to access requests based on the selected node; wherein performing the maintenance operation by the selected node decreases a performance of the selected node.

An embodiment includes a method, comprising: selecting, by a server, a node from among a plurality of nodes to perform a maintenance operation; instructing, by the server, the selected node to perform the maintenance operation; and responding, by the server, to access requests based on the selected node; wherein performing the maintenance operation by the selected node decreases a performance of the selected node.

An embodiment includes a system, comprising: a server coupled to a plurality of nodes and configured to: receive an access request; access a database identifying nodes of the plurality of nodes that are performing one of at least one operation; generate a response to the access request based on the identified nodes; and respond to the access request with the response; wherein performing any of the at least one operation by a node of the plurality of nodes decreases a performance of that node.

### BRIEF DESCRIPTION OF SEVERAL VIEWS OF THE DRAWINGS

FIG. 1 is a schematic view of a system according to some embodiments.

FIG. 2 is a flowchart of a technique of initiating a maintenance operation according to some embodiments.

FIG. 3 is a flowchart of a technique of initiating a maintenance operation according to another embodiment.

FIG. 4 is a schematic view illustrating an access request in the system of FIG. 1 according to some embodiments.

FIG. 5 is a flowchart of a technique of responding to an access request according to some embodiments.

FIG. 6 is a schematic view illustrating an access request in the system of FIG. 1 according to another embodiment.

FIG. 7 is a flowchart of a technique of responding to an access request according to another embodiment.

FIG. 8 is a schematic view of a data storage system according to some embodiments.

FIG. 9 is a schematic view illustrating a read access request in the system of FIG. 8 according to some embodiments.

FIG. 10 is a flowchart of a technique of responding to a read access request according to some embodiments.

FIG. 11 is a schematic view illustrating a write access request in the system of FIG. 8 according to some embodiments.

FIG. 12 is a flowchart of a technique of responding to a write access request according to some embodiments.

FIG. 13 is a schematic view illustrating a modify write access request in the system of FIG. 8 according to some embodiments.

FIG. 14 is a flowchart of a technique of responding to a modify write access request according to some embodiments.

FIG. 15 is a flowchart of a technique of scheduling a maintenance operation of a node according to some embodiments.

FIG. 16 is a flowchart of a technique of scheduling a maintenance operation of a node according to another embodiment.

### DETAILED DESCRIPTION

The embodiments relate to managing operations in centralized distributed systems. The following description is presented to enable one of ordinary skill in the art to make and use the embodiments and is provided in the context of a patent application and its requirements. Various modifications to the embodiments and the generic principles and features described herein will be readily apparent. The embodiments are mainly described in terms of particular methods and systems provided in particular implementations.

However, the methods and systems will operate effectively in other implementations. Phrases such as “an embodiment”, “one embodiment” and “another embodiment” may refer to the same or different embodiments as well as to multiple embodiments. The embodiments will be described with respect to systems and/or devices having certain components. However, the systems and/or devices may include more or less components than those shown, and variations in the arrangement and type of the components may be made without departing from the scope of this disclosure. The embodiments will also be described in the context of particular methods having certain steps. However, the method and system may operate according to other methods having different and/or additional steps and steps in different orders that are not inconsistent with the embodiments. Thus, embodiments are not intended to be limited to the particular embodiments shown, but are to be accorded the widest scope consistent with the principles and features described herein.

The embodiments are described in the context of particular systems having certain components. One of ordinary skill in the art will readily recognize that embodiments are consistent with the use of systems having other and/or additional components and/or other features. However, one of ordinary skill in the art will readily recognize that the methods and systems are consistent with other structures. Methods and systems may also be described in the context of single elements. However, one of ordinary skill in the art will readily recognize that the methods and systems are consistent with the use of systems having multiple elements.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Furthermore, in those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

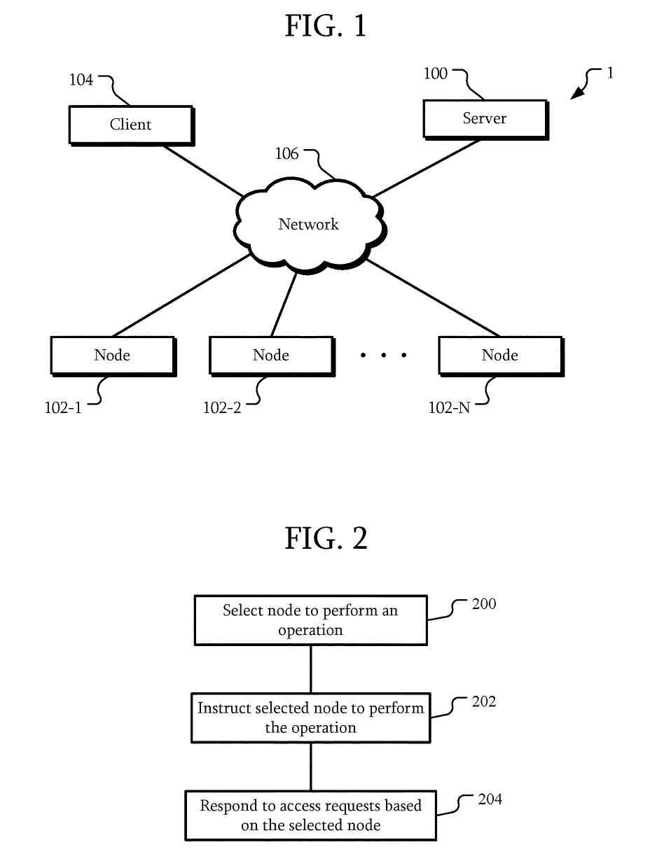

FIG. 1 is a schematic view of a system according to some embodiments. In this embodiment, a server 100 is coupled to multiple nodes 102 through a network 106. Here, nodes 102 are represented by N nodes 102-1, 102-2, and 102-N, representing N nodes. The number of nodes 102 may be any number greater than 1. A client 104 is also coupled to the server 100 and the nodes 102.

The server 100 and nodes 102 are configured as a distributed system 1. For example, the server 100 and nodes 102 may be configured as a distributed data storage system, a distributed computing system, or the like. Such systems 1 may be configured to provide services to clients such as client 104. Here, a single client 104 is illustrated; however, any number of clients 104 may be configured to access the distributed system 1.

The server 100 and nodes 102 may be part of any distributed system 1 in which a node 102 may perform maintenance operations in either the foreground or background that decrease a performance of that node 102. Decreasing performance includes increasing a latency of a node 102, decreasing a throughput of a node 102, or the like. That is, the maintenance operation decreases the performance of the distributed functions of the node 102, such as a data storage function in a distributed storage system, a processing function in a distributed processing system, or the like. In a particular example, decreasing performance may include making the node 102 unresponsive until the maintenance operation is completed. As will be described in further detail below, a garbage collection operation is an example of such a maintenance operation. However, in other embodiments, a refresh operation, a filesystem check operation, wear-levelling operation, or the like may be a maintenance operation. Moreover, any operation that may be periodically performed by a node 102, performed on an as-needed basis by the node 102, or the like to maintain a function of the node 102, increase longevity of the node 102, increase future performance of the node 102, or the like may be a maintenance operation.

The network 106 may be any type of communication network. For example, the network 106 may be a wired network, a wireless network, a combination, or the like. Although the network 106 is illustrated as a single element, the network 106 may include various sub-networks, an ad-hoc network, a mesh network, or the like. In a particular example, the network 106 may include the Internet. In some embodiments, the communication network may include communication networks such as serial attached SCSI (SAS), serial ATA (SATA), NVM Express (NVMe), Fiber channel, Ethernet, remote direct memory access (RDMA), Infiniband, or the like.

The server 100 may be any computing system that is capable of communicating with other devices and/or systems over the network 106. For example, the server may include one or more processors, memories, mass storage devices, network interfaces, user interfaces, or the like. Although the server 100 is illustrated as a single element, the server 100 may be a distributed or aggregate system formed of multiple components.

A node 102 may include a system that is configured to perform an at least some aspect of the services provided by the distributed system 1. For example, the node 102 may be a data storage node. In some embodiments, such a data storage node may be a solid state drive (SSD) including non-volatile memory such as flash memory, spin-transfer torque magentoresistive random access memory (STT-MRAM), or Phase-Change RAM, or the like. In another example, an SSD may be a component of a node 102. In still another example, an SSD may be coupled to the node 102, such as through Ethernet or another communication network. Although an SSD has been used as an example of a node 102, part of a node 102, or a component coupled to a node 102, other types of storage device may be used. In yet another example, the node 102 may be a processing system. Although different examples of nodes 101 have been given, in some embodiments, different types of nodes 102 may be present in a distributed system 1.

FIG. 2 is a flowchart of a technique of initiating a maintenance operation according to some embodiments. The system of FIG. 1 will be used as an example. Referring to FIGS. 1 and 2, in this embodiment, in 200, a node 102 is selected by the server 100 from among the nodes 102 to perform a maintenance operation. The maintenance operation is an operation such as those described herein where performing the maintenance operation by the selected node 102 decreases a performance of the selected node 102.

The server 100 may select the node 102 in a variety of ways. In some embodiments, the server 100 may be configured to monitor access requests to the nodes 102. For example, the server 100 may be configured to determine if future access requests will be reduced. The server 100 may be configured to use historical data on access requests from clients 104 to select a node 102. In a particular example, the server 100 may be configured to determine if an amount of access requests to a node 102 is less than or equal to a threshold. In another example, the server 100 may be configured to analyze historical access requests to the node 102 and determine if there is a period during which the access requests are at an absolute or local minimum. In another example, the server 100 may be configured to identify an end of a particular sequence of access requests involving the node 102. After the end of that sequence, the server 100 may be configured to select the node 102.

In other embodiments, the selection of the node 102 by the server may be according to a predefined algorithm. For example, a random or pseudo-random selection may be made among the nodes 102. In another example, a round-robin selection may be made among the nodes 102. In yet another example, the selection of nodes 102 may be performed according to a schedule. In some embodiments, the server 100 may be configured to determine if a sufficient number of other nodes 102 are available to process anticipated access requests and if so, the server 100 may select the node 102. Although a variety of techniques to select a node 102 have been described above, any technique may be used to select a node 102.

The server 100 may include a memory or other data storage device and may be configured to store a schedule of maintenance operations for the nodes 102, record information related to the access requests which may be analyzed by a processor, or the like to determine if a given node 102 may be selected. Alternatively, the server 100 may store in the memory or other data storage device a state of a selection algorithm.

Once a node 102 is selected, the server 100 may be configured to instruct the selected node 102 to perform the maintenance operation in 202. For example, the server 100 and node 102 may each include network interfaces through which the server 100 and node 102 may communicate through the network 106. The server 100 may transmit an instruction to the selected node 102 through the network 106 identifying the maintenance operation to be performed, a length of time for the maintenance operation, or the like. In a particular example, the server 100 may include the instruction in a heartbeat message transmitted to the selected node 102.

In 204, the server 100 may respond to access requests based on the selected node 102. In particular, the server 100 may respond to access requests by prioritizing access requests, rerouting access requests, reorganizing responses to access requests, designating nodes 102 other than the selected node 102 in responses to access requests, or the like. As a result, reductions in performance of the system 1 due to access requests being routed to nodes 102 performing maintenance operations as described herein may be reduced if not eliminated. That is, as long as the access requests may be routed to other nodes 102, processing of an access request may not experience a reduction in performance due to the selected node 102 performing the maintenance operation. In some embodiments, the server 100 may create explicit times for the maintenance operations to be performed by the nodes. As a result, an impact of the performance of the maintenance operations by the nodes 102 on the apparent performance of the system 1 is reduced.

In some embodiments, once the node 102 has completed the processing according to the instruction in 202, the server 100 may be configured to respond to access requests using the selected node 102 in the usual manner. For example, once a node 102 has performed the maintenance operation for a specified length of time, the node 102 may be returned to a pool of nodes 102 maintained by the server 100 of nodes 102 that are available for the distributed functions of the system 1.

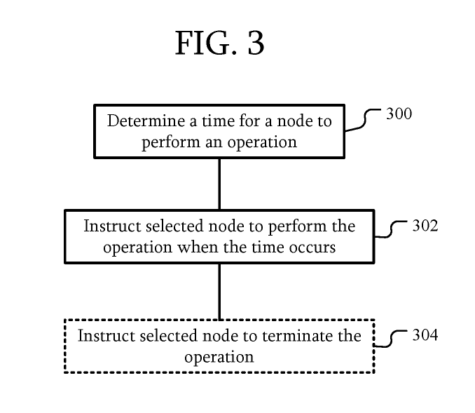

FIG. 3 is a flowchart of a technique of initiating a maintenance operation according to another embodiment. The system of FIG. 1 will be used again as an example. Referring to FIGS. 1 and 3, in 300, the server 100 may be configured to determine a time for a node 102 to perform a maintenance operation. For example, the server 100 may be configured to select nodes 102 according to a schedule. The schedule may define a time for a node 102 to perform the maintenance operation. In 302, when the time occurs for a candidate node 102, the server 100 is configured to select the candidate node 102 as the selected node 102. In other examples, the server 100 may include an algorithm that generates a time for a node 102 to perform a maintenance operation. Although particular examples of determining a time when a maintenance operation is performed have been given, other techniques of determining a time to perform a maintenance operation may be used.

Regardless, in some embodiments, the server 100 may provide a node 102 with an explicit time to perform the maintenance operation. As the time may be scheduled, known according to an algorithm, or the like, the effects of performing the maintenance operation, such as the reduced performance, may be hidden from the client 104. In particular, if the maintenance operation may be scheduled to occur during a time period when accesses to the nodes 102 are reduced in volume or magnitude, then the additional capacity of the system 1 may accommodate access requests while a node 102 or nodes 102 perform the maintenance operation.

In addition, in some embodiments, the server 100 may also be configured to determine a length of time the maintenance operation is performed. Thus, the server 100 may manage not only when a maintenance operation should be performed by a node 102, but also how long the maintenance operation is performed. As a result, the server 100 may manage the availability of nodes 102.

In some embodiments, the server 100 may be configured to instruct the selected node 102 to perform the maintenance operation for a length of time. This length of time may be based on a variety of factors. For example, the length of time may be a predetermined amount of time. In another example, the length of time may be based on a number of nodes 102 and a desired cycle time to perform the maintenance operation on all of the nodes 102. In another example, the length of time may be an amount of time that the node 102 may have a reduced performance without significantly impacting the overall performance of the system. In yet another example, the amount of time may be an average amount of time that a node 102 takes to complete the maintenance operation. In particular, in some embodiments, the server 100 may be configured to monitor a time taken by the nodes 102 in performing the maintenance operation and analyze the times to determine an average time, a distribution of times, or the like to complete the maintenance operation. From this analysis, the server 100 may be configured to generate a length of time for the nodes 102 to perform the maintenance operation. The length of time that nodes 102 are instructed to perform the maintenance operation may be based on that average time, a distribution of the times to perform the maintenance operation, or the like.

In some embodiments, although a node 102 is instructed to perform the maintenance operation for a particular length of time, the node 102 may perform the maintenance operation until another condition occurs. For example, the node 102 may perform the maintenance operation until a particular quantity of atomic operations has been performed. Such atomic operations may include erasing a block, processing a filesystem inode, or the like.

In some embodiments, the length of time each node 102 is instructed to perform the maintenance operation may be different from that of the other nodes 102. For example, the length of time may be based on one or more attributes of the node 102, a length of time the node 102 takes to perform a maintenance operation, a number of atomic operations the node 102 performs in a time period, or the like, which may be different among nodes 102. The server 100 may be configured to query each node 102 to obtain this information, monitor the performance of the nodes 102 to obtain the information, or the like.

In some embodiments, the nodes 102 may each be configured to respond with information on a length of time for an atomic operation. If this length of time is increasing over time, greater than a threshold, has a distribution that covers longer periods of time, or the like the maintenance operation may need to be performed for a longer period of time to accommodate the slower performance. Accordingly, the server 100 may be configured to schedule the node 102 to perform the maintenance operation for a longer period of time than another node 102.

In other embodiments, the nodes 102 may each be configured to respond with an amount of time needed to perform the maintenance operation. For example, a node 102 may be configured to record a number of blocks that are candidates for erasure. The node 102 may be configured to calculate a time needed to erase that number of blocks. The node 102 may respond to the server with that time. Although a particular technique of determining an amount of time, other techniques may be used.

In other embodiments, the length of time may be based on a result of the maintenance operation. For example, a node 102 may be configured to perform a maintenance operation and in response, respond to the server 100 indicating the results of the maintenance operation. If after performing the maintenance operation for the length of time indicated by the server 100, the node 102 may inform the server 100 how many atomic operations of the maintenance operation were completed. If a desired amount was not completed, the server 100 may increase the length of time for the next time the node 102 is instructed to perform the maintenance operation. Although particular techniques that a server 100 may use to customize a length of time for a node 102 to perform a maintenance operation have been used as examples, in other embodiments, different techniques and/or combinations of techniques may be used.

In some embodiments, where the length of time is based on results of operations, measurements, or the like, an additional amount of time may be added to the length of time indicated by the maintenance operations or measurements. For example, an additional length of time may be added to provide some margin for variability in communication, latency, performance of the maintenance operation, or the like.

While a length of time has been used as an example as a condition on the node 102 performing the maintenance operation, other conditions may be used instead of or in addition to the length of time. For example, the maintenance operation may be associated with a number of pages, blocks, files, atomic operations, or other measureable quantity. The instruction from the server 100 provided in 202 of FIG. 2 may include an indication of the quantity. Thus, in response to the instruction in 202, the node 102 may be configured to perform the maintenance operation until the indicated quantity is achieved.

In some embodiments, multiple conditions may be combined together. For example, the instruction from the server 100 provided in 202 of FIG. 2 may include both a length of time and an indication of a quantity. Thus, in response to the instruction in 202, the node 102 may perform the maintenance operation until either or both of the conditions are satisfied. That is, in some embodiments, the node 102 may perform the maintenance operation until both the time has elapsed and the quantity has been achieved. In other embodiments, the node 102 may perform the maintenance operation until one of the conditions has been achieved. For example, if either the time has elapsed or the quantity has been achieved.

In some embodiments, other conditions may be related to time. For example, an atomic operation may take a length of time to perform that is relatively known and/or constant. Accordingly, even if the server 100 instructs a node 102 to perform a particular number of units of the maintenance operation, that amount may be convertible into an amount of time.

In some embodiments, because the server 100 may instruct nodes 102 to perform a maintenance operation for a length of time, the server 100 may be able to schedule the occurrence of the maintenance operations. If the condition provided to the node 102 is convertible into time, the server 100 may still be able to schedule the performance of the maintenance operations of the nodes 102.

In some embodiments, the server 100 may instruct a selected node 102 to terminate a maintenance operation in 304. For example, a load on the distributed system 1 may increase. In response the server 100 may instruct the selected node 102 to terminate the maintenance operation so that the node may be able to respond to access requests without the reduced performance due to performing the maintenance operation. In another example, the server 100 may be configured to determine if an amount of time the node 102 has been performing the maintenance operation is greater than a threshold. If so, the server 100 may then instruct the selected node to terminate the maintenance operation in 304.

In some embodiments, the instruction transmitted to the selected node 102 may include information beyond an instruction to terminate the maintenance operation. For example, the command may include an amount of time that the node 102 should continue performing the maintenance operation before terminating. In another example, the command may include a number of atomic operations to perform before terminating the maintenance operation. Any information regarding operation of the node 102 before, during, and/or after termination of the maintenance operation may be included in the command.

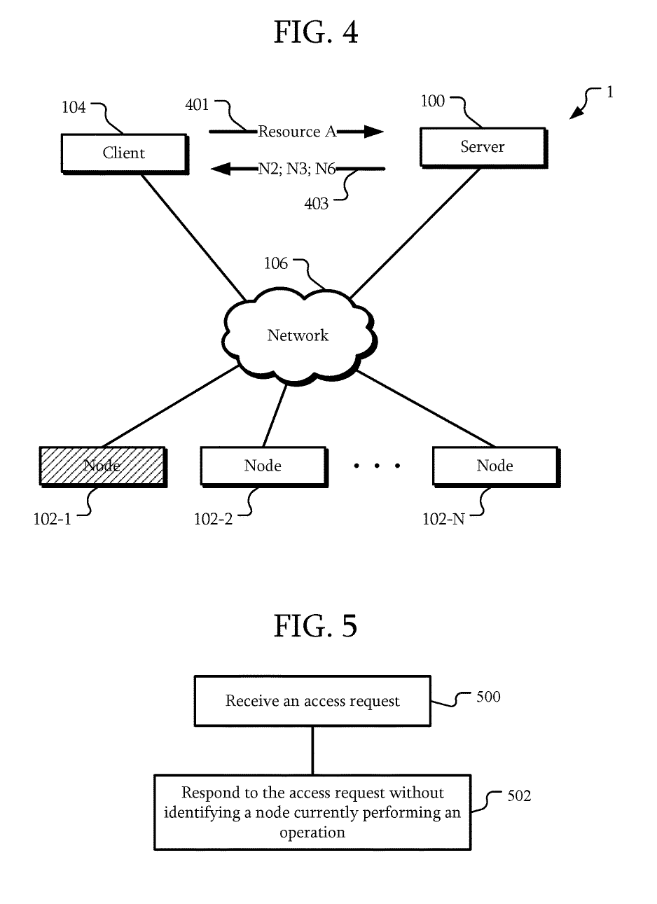

FIG. 4 is a schematic view illustrating an access request in the system of FIG. 1 according to some embodiments. FIG. 5 is a flowchart of a technique of responding to an access request according to some embodiments. Referring to FIGS. 4 and 5, in some embodiments, a client 104 may transmit an access request 401 the server 100 through the network 106. The server 100 receives the access request 401 in 500. Here, the access request 401 is for “Resource A.” “Resource A” may represent a file, a processing resource, a virtual server, storage space, or the like that is provided by the nodes 102 as part of the distributed system 1.

However, node 102-1 is performing a maintenance operation as described above. Thus, the node 102-1 may have a reduced performance or may be unavailable, because the server 100 instructed the node 102-1 to perform the maintenance operation. Here, the node 102-1 is illustrated with a different pattern to indicate that that node 102-1 is performing the maintenance operation when the access request 401 is received by the server 100.

When the server 100 receives the access request 401, the server 100 may access a database identifying nodes 102 that are performing a maintenance operation. In this example, the database may identify node 102-1. That is, the server 100 may have previously instructed the node 102-1 to perform the maintenance operation and updated the database to identify the node 102-1 as performing the maintenance operation, and this information is retained in server 100's database.

The server 100 may generate a response 403 to the access request 401 based on the identified nodes in the database and respond to the access request 401 with the response 403 in 502. Here, the response 403 to the access request 401 does not include an identification of the node 102-1 that is performing the maintenance operation. Instead, the response 403 identifies nodes 102-2, 102-3, and 102-6, represented by N2, N3, and N6, respectively, which are not currently performing the maintenance operation. Accordingly, the server 100 may direct the access request towards nodes 102 that are not performing the maintenance operation. In some embodiments, the node 102-1 that is performing the maintenance operation may have been capable of processing the access request 401; however, because the node 102-1 is performing the maintenance operation, the node 102-1 is omitted from the response 403.

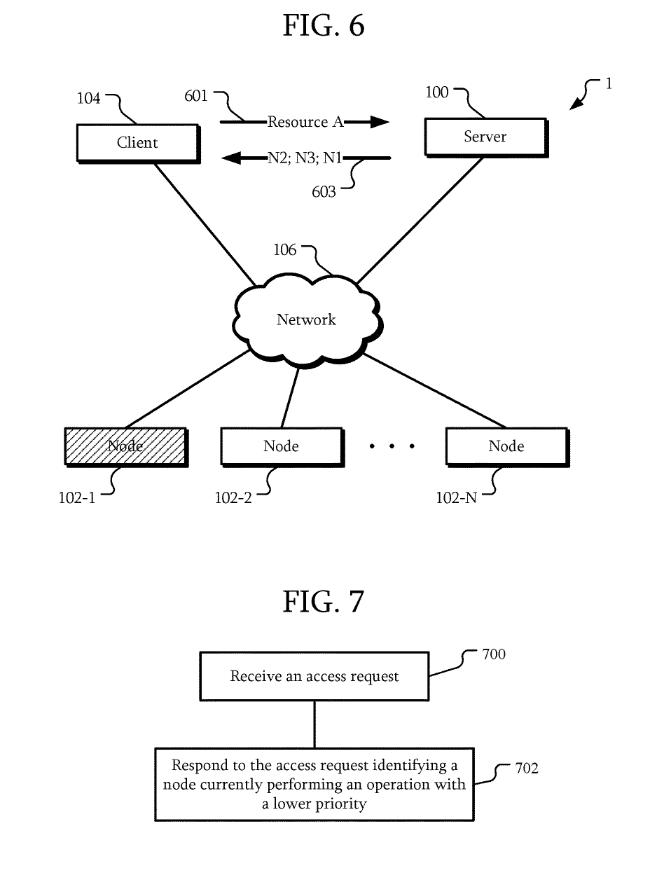

FIG. 6 is a schematic view illustrating an access request in the system of FIG. 1 according to another embodiment. FIG. 7 is a flowchart of a technique of responding to an access request according to another embodiment. Referring to FIGS. 6 and 7, in this embodiment, the system is in a state similar to that of FIG. 4. That is, the node 102-1 has been instructed to perform the maintenance operation. The server 100 again receives an access request 601 in 700. In contrast to the example described above with respect to FIGS. 4 and 5, in this embodiment, the response 603 provided by the server 100 in 702 includes an identification of the node 102-1 instructed to perform the maintenance operation.

Here, the response 603 includes the identification of the node 102-1, represented by “N1.” However, the nodes 102 are listed in an order of priority in the response 603. The node 102-1 is placed in a lower priority position. When the client 104 attempts to access Resource A, the client 104 may attempt to access node 102-2 first, access node 102-3 if that access fails, and access node 102-1 only if the attempts to access both nodes 102-2 and 102-3 fail. As a result, the performance of the maintenance operation by node 102-1 may only impact the performance perceived by the client 104 if both nodes 102-2 and 102-3 are unable to respond.

Although accessing single nodes has been used as an example, in some embodiments, multiple nodes 102 in the response 603 may be accessed. For example, the client 104 may access the first two nodes 102 identified in the response. Thus, the client 104 will attempt to access both nodes 102-2 and 102-3 and will attempt to access node 102-1 if one of the two nodes 102-2 and 102-3 fails. Again, performance perceived by the client 104 may be unaffected unless one of nodes 102-2 and 102-3 is unable to respond.

In some embodiments, the client 104 may access all of the nodes 102 identified in the response in order of priority. As a result, the client 104 may access node 102-1 last. At least some of a performance penalty perceived by the client 104 due to the node 102-1 performing the maintenance operation may be masked by the time taken to access nodes 102-2 and 102-3 before attempting to access node 102-1. For example, as described above, the node 102-1 may have been instructed to perform the maintenance operation for a length of time. By the time the client 104 is ready to access node 102-1, due to the accesses to the other nodes, that length of time may have elapsed or have a reduced amount remaining. Accordingly, the client 104 may be able to immediately access the node 102-1 or wait until the reduced amount of time has elapsed.

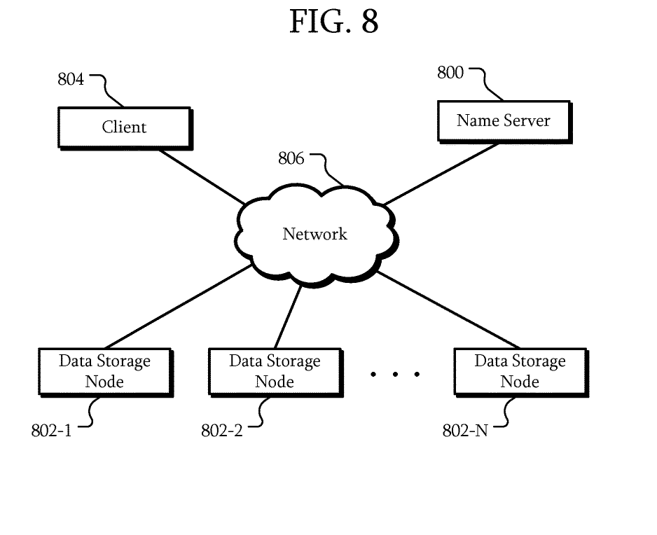

FIG. 8 is a schematic view of a data storage system according to some embodiments. The system illustrated in FIG. 8 may be similar to the system of FIG. 1; however, in some embodiments, the server 100 and nodes 102 may be a name server 800 and data storage nodes 802 of a distributed storage system 8. In addition, for some embodiments, the maintenance operation the nodes 802 are instructed to perform may include a garbage collection operation.

In some embodiments, the name server 800 may be configured to manage the accesses to data and/or files stored in the distributed storage system 8. For example, the name server 800 may include a processor coupled to a network interface and a memory, such as volatile or non-volatile memory, mass storage device, or the like. The memory may be configured to store a database associating data and/or files with nodes 802. In addition, the memory may be configured to store an indication of which nodes 802 have been instructed to perform garbage collection, states of an algorithm to determine when and/or how long nodes 802 should perform garbage collection.

In some embodiments, the data storage nodes 802 may include solid state drives (SSDs). The garbage collection operation performed on the SSDs may include erase operations that take more time to perform than other operations, such as read or write operations. A data storage node 802 may include multiple SSDs. In addition, a data storage node 802 may include other devices and/or systems that may be instructed by the name server 800 to perform operations that may reduce a performance of the data storage node 802. In some embodiments, the system 8 may be in an enterprise environment where SSDs are arranged within clusters. The performance of garbage collection as described herein may improve overall write/read performance on SSDs within the clusters.

Similar to the server 100 described above, the name server 800 may be configured to schedule and/or manage the performance of garbage collection by the nodes 802. In some embodiments, the name server 800 may be configured to determine potential pauses of write/read requests to the data storage nodes 802. The name server 800 may be configured to instruct the nodes 802 to perform garbage collection. In particular, the name server 800 may be configured to instruct the data storage nodes 802 to initiate garbage collection during the pauses in requests. As a result, a reduction in performance due to garbage collection due to the garbage collection being performed in the background during busy write/read command periods may be reduced or eliminated.

As described above, operations may be initiated during particular times and/or according to a schedule. Accordingly, in some embodiments, the garbage collection in the data storage nodes 802 may be similarly initiated. In particular, in SSDs, as a number of free erase blocks is reduced and more may be needed, garbage collection may be initiated and performance may be reduced. By scheduling the performance of garbage collection or otherwise having the garbage collection managed by the name server 800, the system can have improved SSD performance because the garbage collection was performed earlier. As will be described in further detail below, the name server 800 may respond to access requests taking into consideration which data storage nodes 802 are currently performing garbage collection.

In some embodiments, the name server 800 may be configured to reduce and/or stop traffic from being routed to a data storage node 802. As a result, the data storage node 802 may perform garbage collection with reduced or eliminated access. In particular, a data storage node 802 may be relatively uninterrupted in performing garbage collection to create free erase blocks for future writes. Accordingly, future write and reads may experience improved performance.

Once a data storage node 802 has finished performing garbage collection, such as by performing garbage collection for the particular length of time, freed a number of blocks, freed as many blocks as possible, or achieved some other deterministic condition, the name server 800 may re-insert the data storage node 802 into the available pool for receiving data requests from a client 804.

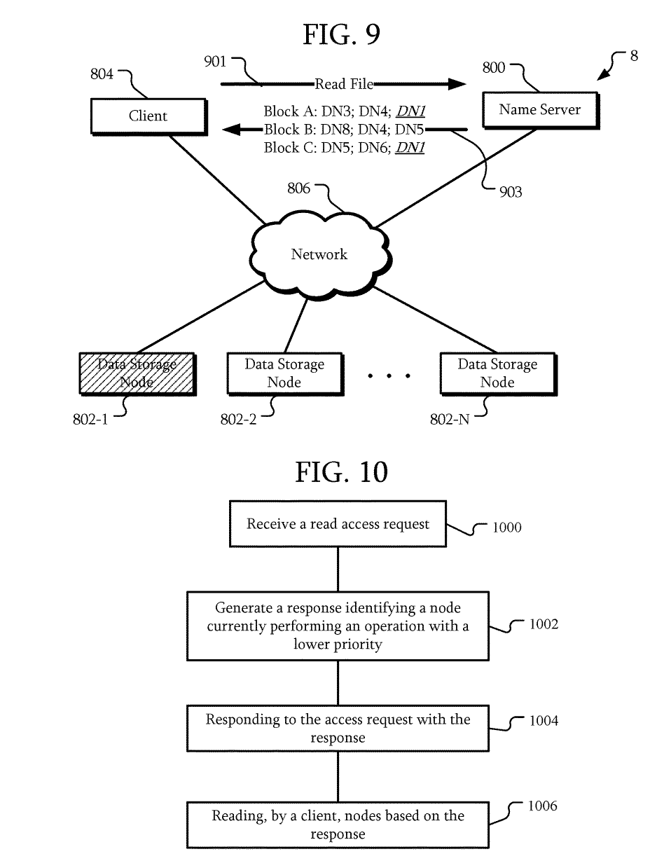

FIG. 9 is a schematic view illustrating a read access request in the system of FIG. 8 according to some embodiments. FIG. 10 is a flowchart of a technique of responding to a read access request according to some embodiments. Referring to FIGS. 9 and 10, in some embodiments, a read file request 901 may be received by the name server 800 from the client in 1000. The client 804 may expect a response indicating which data storage nodes 802 have the blocks that form the requested file.

In 1002, the name server 800 may generate a response 902 identifying data storage nodes 802 where the blocks of the requested file are stored and transmit that response 903 to the client 804 in 1004. In a particular example, the name server 800 may access a database storing identifications of data storage nodes 802 that are currently performing maintenance operations. The name server 800 may generate the response by excluding or reducing the priority of data storage nodes 802 on which the requested file or data is stored that are currently performing maintenance operations or may perform maintenance operations in the near future. After receiving the response 903, the client 804 may be configured to access the data storage nodes 802 based on the response 903 in 1006.

In particular, data storage nodes 802 that are performing garbage collection are ordered in the response 903 to have lower priorities than other data storage nodes 802 in the response 903. In this example, data storage node 802-1 is performing garbage collection. Thus, a performance of data storage node 802-1 may be reduced if accessed.

The response 903 identifies three different blocks A, B, and C of the file associated with the read file request 901. Block A is stored on data storage nodes 802-1, 802-3, and 802-4 as represented by DN1, DN3, and DN4. However, as data storage node 802-1 is performing garbage collection, data storage node 802-1, represented by DN1, is placed in a lower priority position in the response 903 for block A. That is, the client 804 may attempt to access block A at data storage node 802-3 first, data storage node 802-4 second, and data storage node 802-1 last. As a result, a chance that the garbage collection being performed by data storage node 802-1 will impact the performance of reading block A is reduced if not eliminated.

The response 903 identifies data storage nodes 802-4, 802-5, and 802-8 as the data storage nodes 802 storing block B. However, since none of the data storage nodes 802-4, 802-5, and 802-8 is performing garbage collection, the data storage nodes 802-4, 802-5, and 802-8 may not be prioritized any more than the data storage nodes 802-4, 802-5, and 802-8 otherwise would have been.

The response 903 identifies data storage nodes 802-1, 802-5, and 802-6 as the data storage nodes 802 storing block C. Similar to block A, data storage node 802-1, which is performing garbage collection, is one of the data storage nodes storing block C. As a result, data storage node 802-1 has a lower priority in the response 903 than data storage nodes 802-5 and 802-6. Thus, the client 804 may attempt to access the data storage node 802 in the order set forth in the response 903 similar to that described above with respect to block A. For example, the client 804 may attempt to access the first data storage node 802-5 on the list for block C. If there is a failure, the client 804 may attempt to access the second data storage node 802-6 on the list. Finally, the client 804 may attempt to access the last data storage block 802-1. Again, the impact of data storage node 802-1 performing garbage collection may have a reduced if not eliminated impact on the client 804 reading block C due to the reduced priority of the data storage node 802-1.

Although only one data storage node 802-1 is illustrated as performing garbage collection, other data storage nodes 802 may be performing garbage collection when a read request 901 is received. Accordingly, if blocks associated with the read requests 901 are stored on any of the data storage nodes 802 performing garbage collection, those data storage nodes 802 may be added to the response 903 with a lower priority.

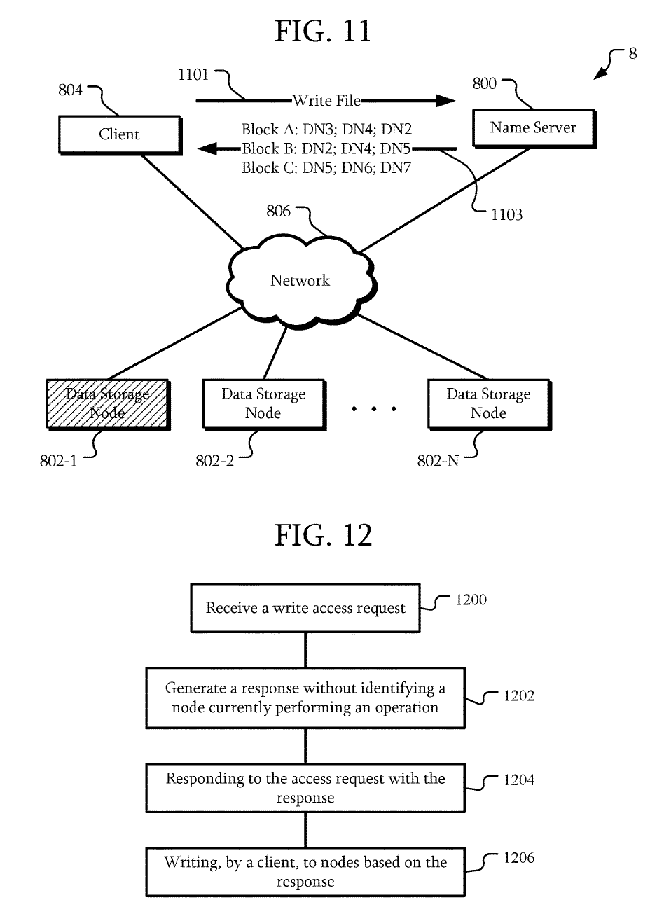

FIG. 11 is a schematic view illustrating a write access request in the system of FIG. 8 according to some embodiments. FIG. 12 is a flowchart of a technique of responding to a write access request according to some embodiments. Referring to FIGS. 11 and 12, in some embodiments, the name server 800 may receive a write access request 1101 from a client 804 in 1200. In this example, data storage node 802-1 is again performing garbage collection.

In response to the write access request 1101, the name server 800 may be configured to generate a response that does not identify a data storage node 802 that is currently performing garbage collection in 1202. In some embodiments, no data storage node 802 that is currently performing garbage collection will be returned in a response 1103. Here, the response 1103 indicates that block A should be written to data storage nodes 802-2, 802-3, and 802-4, block B should be written to data storage nodes 802-2, 802-4, and 802-5, and block C should be written to data storage nodes 802-5, 802-6, and 802-7. The response 1103 does not include data storage node 802-1 in any of the lists of data storage nodes 802.

In some embodiments, the name server 800 may be configured to allow blocks to be duplicated across a limited number of data storage nodes 802. For example, a number of data storage nodes 802 to which block A may be duplicated may be limited to a maximum of 3. The name server 800 may be configured to instruct a number of data storage nodes 802 to enter garbage collection at any one time such that a number of remaining data storage nodes 802 is greater than or equal to the limit on the number of data storage nodes 802 for duplication of a given block. As a result, a number of data storage nodes 802 necessary to respond to the write access request 1101 may be available without identifying any data storage node 802 currently performing garbage collection. Using the limit of a maximum of 3 data storage nodes 802 as an example, the name server 800 may schedule the performance of garbage collection by the data storage nodes 802 such that the number of data storage nodes 802 not performing garbage collection is greater than or equal to 3.

In some embodiments, the name server 800 may be configured to base the identification of the data storage nodes 802 on potential scheduled garbage collection. For example, if the name server 800 has data storage node 802-2 scheduled for garbage collection after data storage node 802-1 has completed garbage collection, the name server 800 may omit data storage node 802-2 from the response 1103. The name server 800 may instead use another data storage node 802, such as a data storage node 802 that had recently completed garbage collection.

In other embodiments, the distribution of the data storage nodes 802 in the response 1103 may be selected based on the scheduled garbage collection. For example, available data storage nodes 802 may be returned in response 1103 such that when one of those data storage nodes 802 is instructed to perform garbage collection, a number of blocks potentially impacted by that data storage node 802 performing garbage collection is minimized. In a particular example, the response 1103 may include a distribution of data storage nodes 802 such that numbers of the usages of the data storage nodes 802 are substantially equal.

Once the data storage nodes 802 for the response 1103 have been determined and the response 1103 is generated, the name server 800 may respond to the client 804 in 1204. As a result, the client 804 may write to data storage nodes 802 based on the response 1103 in 1206. In this example, none of the data storage nodes 802 in the response 1103 includes the data storage node 802-1 that is performing garbage collection. As a result, the client 804 should not be impacted be the data storage node 802-1 performing garbage collection.

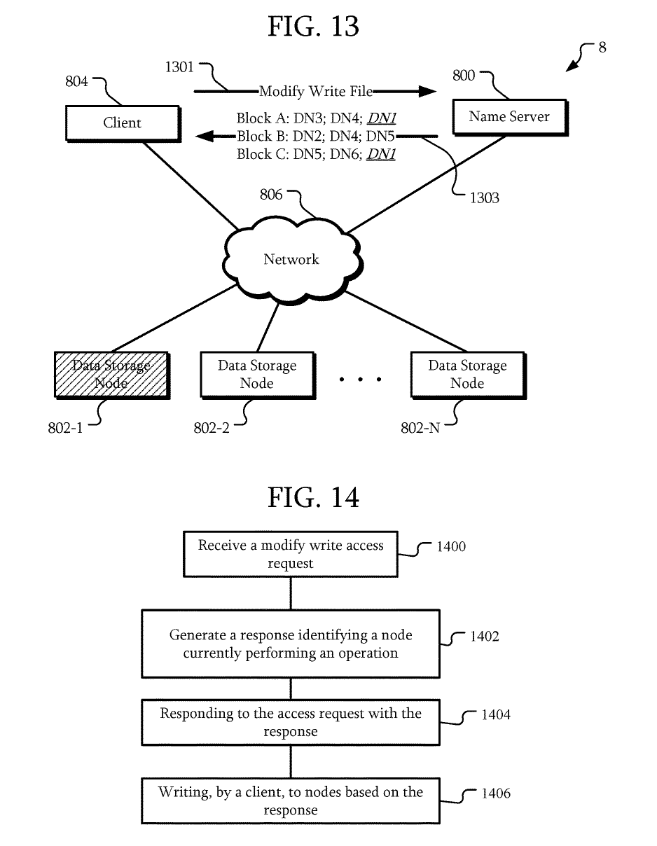

FIG. 13 is a schematic view illustrating a modify write access request in the system of FIG. 8 according to some embodiments. FIG. 14 is a flowchart of a technique of responding to a modify write access request according to some embodiments. Referring to FIGS. 13 and 14, in some embodiments, the name server 800 may receive a modify write access request 1301 from a client 804 in 1400. In this example, data storage node 802-1 again may be performing garbage collection. Here, the operations of the name server 800 and, in particular, the technique of 1400, 1402, 1404, and 1406 of FIG. 14 may be similar to the operation of the name server 800 described above with respect to FIG. 12. However, since in this embodiment the write is modifying existing blocks, the name server 800 may not be able to omit data storage nodes 802 that are currently (or may soon be) performing garbage collection.

To reduce an impact that the garbage collection of the data storage node 802-1 may have on the writing of the client 804, the name server 800 may be configured to order the data storage nodes 802 in the response 1303 such that data storage nodes 802 that are performing garbage collection have a reduced priority in the list. While data may eventually be written to the data storage node 802-1 for blocks A and C, a delay due to the garbage collection may be masked by the time taken to write to the higher priority data storage nodes 802 for those blocks.

In some embodiments, the client 804 may be configured to write to only the first data storage node 802 in the response 1303 for a given block. The data storage nodes 802 may be configured to forward the write data to the other data storage nodes 802 in the list. For example, for block A of the response 1303, data storage node 802-3 may write data to data storage node 802-4 and data storage node 802-4 may write to data storage node 802-1. As data storage node 802-1 may still be performing garbage collection when data storage node 802-4 attempts a write, one or more of the client 804, data storage node 802-3, data storage node 802-4, and data storage node 802-1 may buffer the data until a write may be performed on the data storage node 802-1.

While garbage collection has been used as an example of a maintenance operation in the context of a distributed storage system 8, the maintenance operation performed by the node may be different or include other operations. For example, the maintenance operation may include a filesystem maintenance operation.

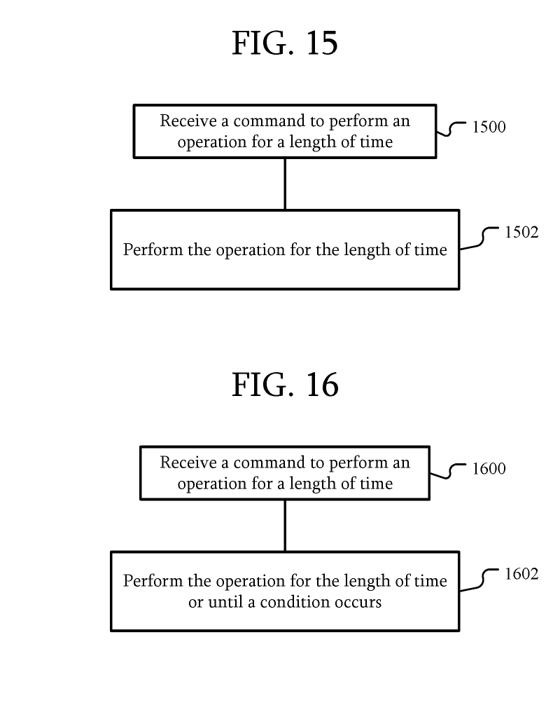

FIG. 15 is a flowchart of a technique of scheduling a maintenance operation of a node according to some embodiments. The system of FIG. 1 will be used as an example. Referring to FIGS. 1 and 15, in 1500, a node 102 may receive a command to perform a maintenance operation for a length of time. In response, in 1502, the node may perform the maintenance operation for the length of time. Referring to FIGS. 8 and 15, the data storage node 802 may similarly receive a command to perform garbage collection for a length of time and then perform that garbage collection for the length of time.

FIG. 16 is a flowchart of a technique of scheduling a maintenance operation of a node according to another embodiment. The technique illustrate in FIG. 16 may be similar to that of FIG. 15 and, in particular, similar to that described above with respect to FIG. 15 and FIG. 1 or 8. However, in this embodiment, when the node 102 of FIG. 1 or data storage node 802 of FIG. 8 may be configured to perform the maintenance operation or garbage collection, respectively, until either the length of time elapses or a condition occurs. As described above, the condition may be a completion of the maintenance operation, a completion of a number of atomic operations, erasing of a number of blocks, or the like.

Although the structures, methods, and systems have been described in accordance with particular embodiments, one of ordinary skill in the art will readily recognize that many variations to the disclosed embodiments are possible, and any variations should therefore be considered to be within the spirit and scope of the apparatus, method, and system disclosed herein. Accordingly, many modifications may be made by one of ordinary skill in the art without departing from the spirit and scope of the appended claims.

1. A system, comprising:
a server coupled to a plurality of nodes and configured to:
select a node from among the nodes to perform a maintenance operation; <instruct the selected node to perform the maintenance operation; and
respond to access requests based on the selected node;
wherein performing the maintenance operation by the selected node decreases a performance of the selected node.

2. The system of claim 1, wherein:
the nodes are data storage nodes; and
the maintenance operation comprises garbage collection.

3. The system of claim 1, wherein the server is configured to:
determine a time when a magnitude of predicted accesses of a candidate node of the nodes is less than a threshold; and
select the candidate node as the selected node when the time occurs.

4. The system of claim 1, wherein the server is configured to instruct the selected node to perform the maintenance operation for a length of time.

5. The system of claim 4, wherein the server is configured to determine the length of time.

6. The system of claim 5, wherein the server is configured to determine the length of time based on performance of the selected node.

7. The system of claim 5, wherein the server is configured to determine the length of time based on a quantity of free blocks.

8. The system of claim 1, wherein the server is configured to respond to a write access request with a list of nodes excluding the selected node when the selected node is performing the maintenance operation.

9. The system of claim 8, wherein:
the server is configured to respond to a modify write access request with a list of nodes including the selected node when the selected node is performing the maintenance operation; and
the selected node has a lower priority in the list of nodes than at least one other node in the list of nodes.

10. The system of claim 8, wherein the server is configured to select the nodes of the list of nodes based on a schedule of maintenance operations for the nodes.

11. The system of claim 1, wherein the server is configured to respond to a read access request with a list of nodes where the selected node has a lower priority than other nodes in the list when the selected node is performing the operation.

12. A method, comprising:
selecting, by a server, a node from among a plurality of nodes to perform a maintenance operation;
instructing, by the server, the selected node to perform the maintenance operation; and
responding, by the server, to access requests based on the selected node;
wherein performing the maintenance operation by the selected node decreases a performance of the selected node.

13. The method of claim 12, wherein:
the nodes are data storage nodes; and
the maintenance operation comprises garbage collection,

14. The method of claim 12, further comprising:
determining, by the server, a time when a magnitude of predicted accesses of a candidate node of the nodes is less than a threshold; and
selecting, by the server, the candidate node as the selected node when the time period occurs.

15. The method of claim 12, further comprising instructing, by the server, the selected node to perform the maintenance operation for a length of time.

16. The method of claim 15, further comprising determining, by the server, the length of time.

17. The method of claim 12, further comprising responding, by the server, to a write access request with a list of nodes excluding the selected node when the selected node is performing the maintenance operation.

18. The method of claim 17, further comprising:
responding, by the server, to a modify write access request with a list of nodes including the selected node when the selected node is performing the maintenance operation; and
wherein the selected node has a lower priority in the list of nodes than at least one other node in the list of nodes.

19. The method of claim 12, responding, by the server, to a read access request with a list of nodes with the selected node having a lower priority when the selected node is performing the operation.

20. A system, comprising:
a server coupled to a plurality of nodes and configured to:
receive an access request;
access a database identifying nodes of the plurality of nodes that are performing one of at least one maintenance operation;
generate a response to the access request based on the identified nodes; and
respond to the access request with the response;
wherein performing any of the at least one maintenance operation by a node of the plurality of nodes decreases a performance of that node.
